(19) United States
(12) Patent Application Publication
(10) Pub. No.: US 2025/0175337 A1
(43) Pub. Date: May 29, 2025

(54) INFORMATION PROCESSING DEVICE, COMPUTER PROGRAM PRODUCT, AND INFORMATION PROCESSING METHOD

(71) Applicant: SUSHI TOP MARKETING, Inc., Chiyoda-ku, Tokyo (JP)

(72) Inventors: Daisuke TOKUNAGA, Chiyoda-ku, Tokyo (JP); Daisuke OTSUKA, Chiyoda-ku, Tokyo (JP); Nobuyuki TAKAHASHI, Chiyoda-ku, Tokyo (JP); Takayuki SUZUKI, Chiyoda-ku, Tokyo (JP)

(21) Appl. No.: 18/842,533

(22) PCT Filed: Mar. 1, 2023
(86) PCT No.: PCT/JP2023/007593

§ 371 Date: Aug. 29, 2024

(30) Foreign Application Priority Data
Mar. 2, 2022 (JP) 2022-032138

(51) Int. Cl. H04L 9/32; G06Q 20/36; H04L 9/00; H04L 9/08

(52) U.S. Cl. CPC H04L 9/3213; G06Q 20/367; H04L 9/0869; H04L 9/50

(57) ABSTRACT

Disclosed is an information processing device configured to perform a first process based on an acquisition request generated by a user terminal to acquire a token that can be circulated on a blockchain network made up of a plurality of computers. The first process generates predetermined information that enables the acquisition or management of the token and stores the predetermined information in a predetermined storage area pertaining to the user terminal or a server.

### CROSS-REFERENCE TO RELATED APPLICATIONS

This application is a national stage entry of International Application No. PCT/JP2023/007593 filed on Mar. 1, 2023, which claims the benefit of priority to Japanese Application No. 2022-032138, filed Mar. 2, 2022, the entire disclosures of which are hereby incorporated herein by reference.

### TECHNICAL FIELD

The present disclosure relates to an information processing device, a computer program product, and an information processing method.

### BACKGROUND ART

As for how to issue and control tokens that are managed on a blockchain, the advent of Bitcoin, which represents value and is transferable without an electronic and centralized system, has led to the widespread use of blockchain technology that makes this possible. As understanding of the concept of Bitcoin and blockchain technology advances, various other coins that electronically represent value are emerging in addition to Bitcoin. These coins of value will be hereinafter referred to as tokens. Due to the nature of the blockchain technology, issued tokens have a feature that they are extremely difficult to tamper with. Taking advantage of this feature, blockchain is increasingly being used to record the owners of various electronic data, such as images, videos, and audio, in order to guarantee and prove their ownership. Tokens used for this purpose are called non-fungible tokens (NFTs). Although the concept of NFTs themselves has been around for a long time, NFTs have been gradually gaining recognition since around 2017 and are attracting attention as some have been traded at high prices in 2021. As specific applications of NFTs, there have been proposed intangible asset management (see Patent Document 1) and contract/license management (see Patent Document 2). The use of a decentralized system with blockchain, instead of a conventional system managed centrally by an administrator, increases fault tolerance. In addition, even if the central administrator is unable to perform their duties, the recorded information is still available without problems.

### PRIOR ART DOCUMENT

### Patent Document

Patent Document 1: Japanese Patent No. 6640320
Patent Document 2: Japanese Unexamined Patent Publication No. 2020-068388

### SUMMARY OF THE INVENTION

### Problems to be Solved by the Invention

Currently, NFTs have the following problems: creating an NFT requires expert knowledge as the NFT technology is new, and it is also difficult for users to acquire tokens such as NFTs unless they understand how to transact on a blockchain.

It is therefore an object of the present disclosure to effectively assist users in acquiring and managing tokens.

### Means for Solving the Problems

According to an aspect of the present disclosure, there is provided an information processing device configured to perform a first process based on an acquisition request generated by a user terminal to acquire a token that can be circulated on a blockchain network. The first process generates predetermined information that enables the acquisition or management of the token and stores the predetermined information in a predetermined storage area pertaining to the user terminal or a server.

### Effects of the Invention

According to the present disclosure, it may be possible to effectively assist users in acquiring and managing tokens.

### BRIEF DESCRIPTION OF THE DRAWINGS

FIG. 1 is a diagram illustrating a basic configuration according to an embodiment.

FIG. 2 is a diagram illustrating the configuration of each node, or a user terminal and a token control processing reception unit, that make up a blockchain network.

FIG. 3 is a diagram illustrating a token generation process.

FIG. 4 is a diagram illustrating token control information to be set in a distribution means.

FIG. 5 is a diagram illustrating a received data storage unit.

FIG. 6 is a diagram illustrating token management information for a smart contract.

FIG. 7 is a diagram illustrating the management of the number of tokens distributed.

FIG. 8 is a flowchart illustrating a token receiving process according to a third embodiment.

FIG. 9 is a diagram (1) illustrating a screen image for explaining the token receiving process according to the third embodiment.

FIG. 10 is a diagram (2) illustrating a screen image for explaining the token receiving process according to the third embodiment.

FIG. 11 is a diagram (3) illustrating a screen image for explaining the token receiving process according to the third embodiment.

FIG. 12 is a diagram illustrating a screen image for instructing a change in the storage location of a held token.

FIG. 13 is a diagram illustrating a screen image for explaining the options for storing a token.

### MODES FOR CARRYING OUT THE INVENTION

Exemplary embodiments will be described in detail below with reference to the accompanying drawings.

### First Embodiment

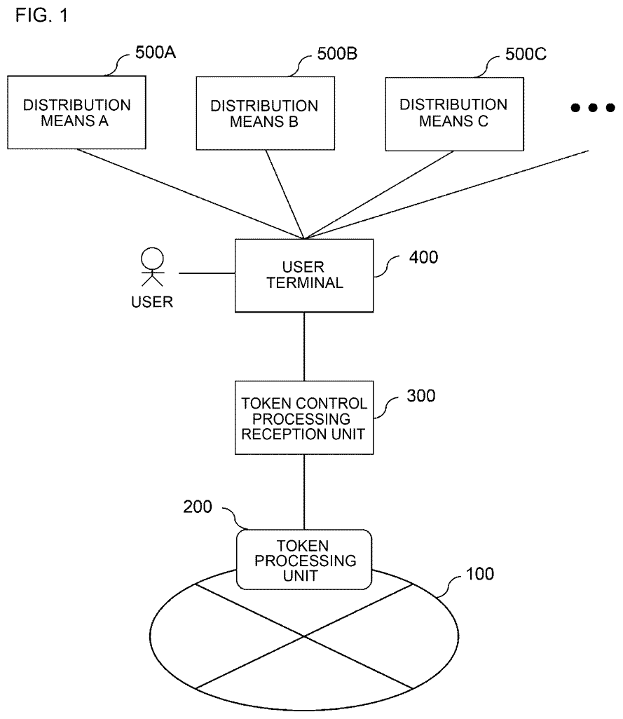

FIG. 1 is a diagram illustrating the overall configuration of a system for implementing an embodiment.

A blockchain network 100 is a network that connects a large number of computers, each of which is referred to as a node. When a transaction or processing request is issued to the blockchain network 100 from the outside, each node records the processing request, performs processing according to the processing request from a user, and stores the result in a storage managed by the node. The processing request is communicated to each node, and each node performs the same processing for the processing request and records the output, allowing each node to have exactly the same information even in a decentralized or distributed environment. The processing that takes place on the blockchain is called a smart contract.

A smart contract is a computer program that is executed on each node. As with the processing request, having received a registration request for a program, the blockchain network 100 distributes it to all nodes so that they each register it. A token processing unit 200 corresponds to the smart contract and controls tokens in response to requests from users. In this embodiment, the issuance of a token will be described as an example.

A token control processing reception unit 300 is a server that interacts with the blockchain network 100. Upon receipt of a request from a user terminal 400, the token control processing reception unit 300 makes a request to the token processing unit 200 and returns a response therefrom to the user terminal 400. The user terminal 400 is an information processing device used by a user, such as a smartphone or a PC. Distribution means A to C (500A to 500C) provide users with information related to a token (e.g., part or all of token control information, described later). Specifically, in cooperation with the user terminal 400, the distribution means A to C provide various data including uniform resource locator (URL), QR code, near-field communication (NFC), Bluetooth (registered trademark), audio, image, beacon information, location information, and behavior of external servers such as information on the application programming interface (API) of social networking service (SNS). When a user directly interacts with the blockchain network 100, hardware or software that manages a private key used in the blockchain, called a wallet, is used on the user's terminal. If a wallet is already installed on the user terminal 400, a processing request may be sent directly from the user terminal 400 to the token processing unit 200 without going through the token control processing reception unit 300. In this embodiment, assuming that many users do not have a wallet, an example will be described in which they use the token control processing reception unit 300.

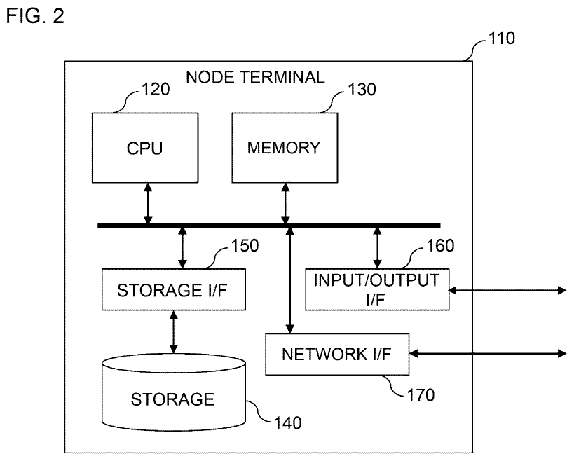

FIG. 2 is a diagram illustrating the configuration of each of the nodes that make up the blockchain network 100. A node terminal 110 may be an ordinary computer and may include: a central processing unit (CPU) 120; a memory 130; a storage 140; a storage interface (I/F) 150 which is an interface for connecting to the storage; an input/output I/F 160 for connecting to external devices such as a keyboard, mouse, and display; and a network I/F 170 for connecting to an external computer to form a network. Although not illustrated, some node terminals have a graphics processing unit (GPU) or field-programmable gate array (FPGA) as other computational processing units and offload processing required for blockchain operations, such as mining, to these functional units. In the node terminal 110, information on the blockchain network is stored in the storage 140, and tasks of a smart contract are loaded from the storage 140 into the memory 130 and executed by the CPU 120 (or, in some cases, by the GPU or FPGA). The token control processing reception unit 300 and the user terminal 400 may also be ordinary computers and have the same configuration as the node terminal 110.

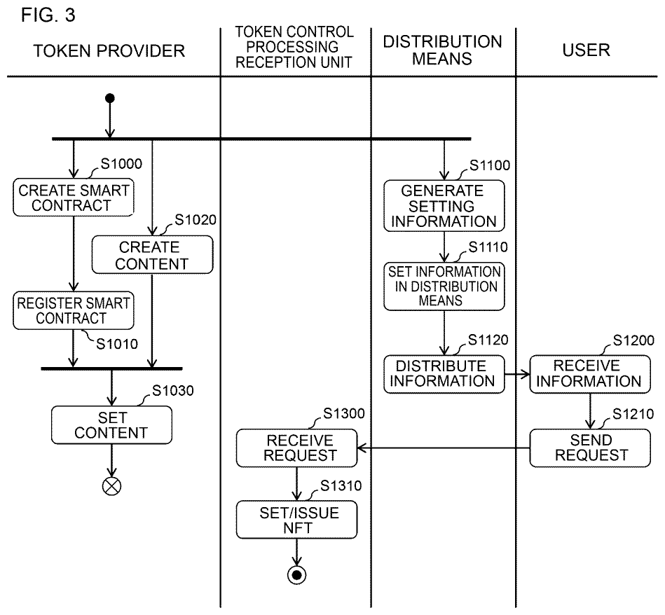

In order to distribute tokens such as NFTs to users, it is necessary to create tokens in advance or prepare a mechanism to create tokens on request. FIG. 3 illustrates a process from the preparation to the point where a user actually receives a token. This process will be described below assuming that an NFT is newly issued.

First, in order to issue an NFT, it is necessary to develop or create a smart contract to manage and operate the NFT (step S1000). When it has been confirmed that the created smart contract is free of bugs, the smart contract is registered on the blockchain network 100 (step S1010). Note that the blockchain network 100 and the smart contract are not included in this flowchart. Concurrently, content to be referenced as the NFT is created, and information to be registered in the smart contract is prepared (step S1020). Once the smart contract and content are prepared, the information is set in the smart contract, and the creation work is completed (step S1030). In this embodiment, the content information is registered after the smart contract is registered on the blockchain network 100 as described above. However, rather than setting the content information after the registration of the smart contract, all the information may be prepared and then registered as a smart contract after the content information is also finalized.

In this embodiment, a distribution means can be prepared in parallel with the development/creation of the smart contract and content, and this is implemented in a setting information generation process (step S1100). In the process, random numbers with a sufficient range are used as the setting information. For example, a number in the range of 2 to the power of 256 may be assigned as a random number. The larger the space that can be set, the less likely it is that the random numbers generated will match. Depending on the distribution means, tasks such as printing or writing data to a dedicated device may be required. It is required to wait for the creation to be completed on the NFT side to establish a one-to-one correspondence between information provided by a distribution means such as a QR code and ID information managed by the NFT. However, once certain preparations and rules, such as the URL of the site to be accessed, have been determined, a distribution means can then be generated freely using a random number. In this manner, the process can be carried out independently of the creation, and the procedures on the distribution means side can also be performed mechanically. Alternatively, a rule may be defined in which a numeric range for use is assigned to each distribution means, and serial numbers in the range are used instead of random numbers.

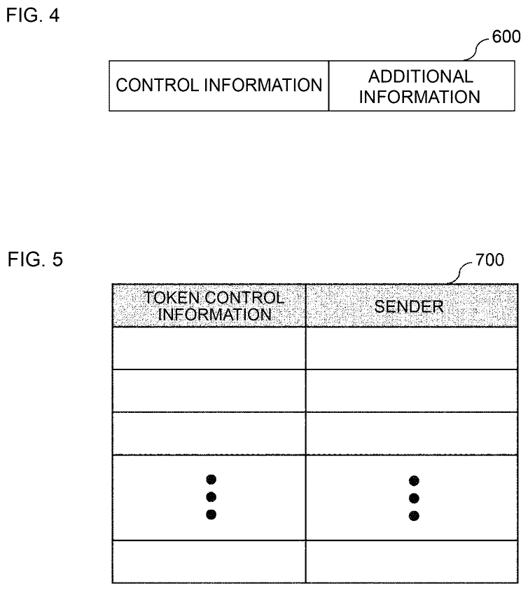

For example, numbers from 1 to 10000 are assigned to the QR code, numbers from 10001 to 20000 are assigned to the NFC, and so forth such that all the numbers are unique. The information thus generated set in a distribution means (step S1110) and distributed to the user (step S1120). Since creation and distribution can be separated, pre-sales can be made available, making it easier to collaborate with other products. FIG. 4 illustrates token control information 600, which is information provided by the distribution means to the user terminal. Here, it is assumed that a random number or a predefined serial number used to issue or distribute an NFT is set as control information, and the URL of the access destination for acquiring the NFT and the like are stored as additional information. The additional information may include information other than the URL of the access destination. Examples of such information include the type of distribution means, a control number, the date and time the sale begins, and the URL of the provider.

Thereafter, the user receives, for example, a QR code printed as the distribution means and scans it with a smartphone or the like to obtain information on the access destination and a random number set for redemption of an NFT (step S1200). The user then notifies the obtained access destination of the retrieved random number and requests the acquisition of the NFT (step S1210). When notifying the access destination of the random number, the user also sends information to receive the NFT (in the case of a public blockchain, the information corresponds to the user's address and is hereinafter referred to as the address).

In this embodiment, the token control processing reception unit 300 is set as the access destination and receives the request from the user (step S1300). FIG. 5 illustrates a received data storage unit 700 that stores information received by the token control processing reception unit. In this example, the user's address in the blockchain network 100 is stored in the sender field; however, if necessary, information that reliably identifies an individual or their user terminal 400, such as the user's IP address, may be stored. In addition, if all or part of the additional information of the token control information is not required, it may be deleted before being stored in the token control information field of the received data storage unit 700.

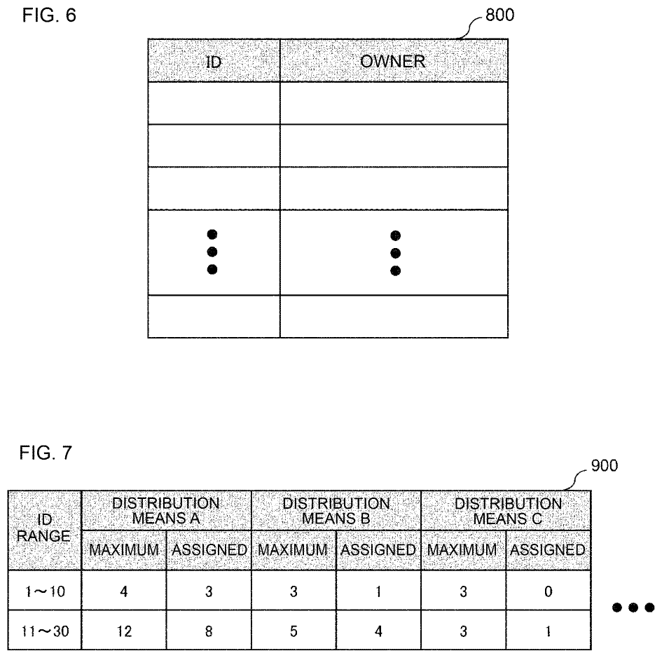

When storing the received data, the token control processing reception unit 300 checks whether there is one with the same token control information. If the same information has already been registered, the token control processing reception unit 300 informs the user that the content of the distribution means has already been used, and the process ends. When the same user is allowed to have a plurality of NFTs, such as “up to three per person,” the token control processing reception unit 300 checks whether the number has been reached. If the number has already been reached, the process ends. The upper limit number per user may be checked by the smart contract rather than by the token control processing reception unit 300. If the check is performed and there is no problem, the received information is stored as it is. The received information is used to request the smart contract to issue or set the NFT (step S1310); note that the smart contract is not included in this flowchart. Upon receipt of the request to issue or set the NFT, the smart contract confirms that the notification is in order and then changes the owner of the subject NFT to the user. Alternatively, the smart contract may issue a new NFT and set the user as its owner. The smart contract that manages and operates NFTs has token management information 800, including NFT IDs and owner information. FIG. 6 is a diagram illustrating an example of the token management information 800 of the smart contract. The simplest approach is to set the notified random number or serial number as it is as an ID, associate the ID with the notified user's address, and store them as the token management information 800. Although there is an upper limit to the ID values that can be taken due to implementation constraints of the smart contract, the constraints can be circumvented if the information to be set as transmission information is defined taking this into account when random numbers or serial numbers are assigned. Additionally, in many cases, there is an upper limit on the number of NFTs, such as 100, 10000, or the like. One method for dealing with this case may be to find the remainder of the received random number. For example, if there are 100 NFTs to be distributed, the received random number is divided by 100, and the remainder is used as the ID. The use of the remainder allows the ID value to be kept within a certain range no matter what number is notified. In this case, however, it is possible that the calculated remainder of a random number notified later may be the same value as an ID that has already been used. This can be dealt with by using closed hashing, in which the value next to the calculated value is used as the ID, or other methods. If the maximum number of NFTs has already been assumed when serial numbers are assigned, the values in the number may be used as IDs as they are.

In addition, attempts are being made to limit the number of NFTs that can be issued in order to reduce the number in circulation and make them scarce. According to the embodiment, this can be achieved by limiting the number of NFTs provided by the distribution means.

Another possible way to achieve scarcity is to create a scarcity value through the range of IDs. For example, if there are 100 NFTs, NFTs 1 through 10 may be made more valuable (by associating them with special content, etc.). The remainder can also be used to realize this; however, it may happen that the value of the remainder is 10 and is then shifted to 11 due to the use of closed hashing, resulting in the user not receiving a valuable NFT. This can be dealt with by specifying a range to use closed hashing when the remainder is between 1 and 10, instead of simply using closed hashing.

However, since this embodiment assumes the use of a plurality of distribution means, there is a possibility that a large number of high-value NFTs may be distributed through a particular distribution means. Because some distribution means may limit the users who can receive them, it is also necessary to ensure fairness in distribution. This may be managed by, for example, a token distribution number management 900 as illustrated in FIG. 7. The token distribution number management 900 is information for managing which and how many IDs are to be assigned for each distribution means that is expected to be used, which is used to manage the maximum number of IDs to be assigned, as well as the number of IDs actually assigned after distribution has begun. This information is also referenced when an ID is assigned to a user with a smart contract. As to which ID should be assigned when the remainder of transmission information, which is notified after the maximum number of IDs have been assigned through a certain distribution means, falls within that range, the developer may define it in a smart contract based on the NFT concept, operational rules, and the like. Although only ranges of IDs are simply defined in the example of FIG. 7, it may also be possible to use time constraints, such as within one month or three months of the start of sales, or statistics for the total number of receptions, or to create rules that combine these factors.

In this embodiment, an example has been described in which an NFT is acquired using information obtained from a distribution means. In practice, a plurality of distribution means may be used, such as when NFT distribution information is provided by a QR code and broadcast audio at the same location. In this case, there may be applications in which an NFT is issued only when token distribution information provided by a plurality of distribution means is received, or a special NFT is issued when a plurality of distribution means are used. By combining a plurality of distribution means in this manner, it is possible to distribute NFTs according to location and time without adding any further information to the transmission information or additional information. In addition, if an NFT is not issued to a user who only has a QR code, for example, it may also provide some security measures.

Furthermore, although the above example has been described assuming the process of issuing an NFT, the mechanism can also be used to perform not only issuing but also other processes for tokens, including NFTs, on the blockchain network 100. For example, the mechanism can also be used to create a service that links the real world with NFT information, such as when an NFT used in a game improves the parameters if users go to a certain location at a certain date and time.

In this embodiment, as an example, a configuration has been described in which a user sends a processing request to the token processing unit 200 via the token control processing reception unit 300. However, when it becomes common that a wallet is installed on the user terminal 400, it is likely that the user may often directly notify the token processing unit 200 of the token control information 600 and request processing. In this case, the received data storage unit 700 managed by the token control processing reception unit 300 may be managed by the token processing unit 200, a smart contract, to implement the embodiment.

### Second Embodiment

Through the method of the first embodiment described above, distribution information can be created independently of content creation, and tokens such as NFTs can be distributed to users in advance using various distribution means. However, if the distribution means are simply used to limit the number of tokens or to distribute high-value tokens, there may be a risk of abuse. Taking the use of a QR code as an example, anyone can obtain the information of the QR code itself and easily check its contents. In other words, users can easily obtain information such as the URL of an access destination and random numbers or serial numbers used for ID assignment. In addition, since QR code creation tools are publicly available on the Web and the like, when a user receives a QR code, the user can tamper with the original information and then send a processing request to the token control processing reception unit 300. This poses two major problems: users can acquire a token with any ID they like, and they can acquire as many tokens as they like without obtaining information from the distribution means.

The problem that users can acquire a token with any ID can be addressed by modifying the random number on the receiving end. For example, having received a request from a user (step S1300), the token control processing reception unit 300 may generate a random number and combine it (by XOR, etc.) with the received random number to create new information, which is then used as information for ID assignment. Instead of generating a random number, a hash value may be obtained from a salt (arbitrary random data) and the notified information to be used as assignment information. This problem can be addressed by not using the information notified by the user as it is. Note that, although an example has been described in which the token control processing reception unit 300 generates and combines random numbers or creates a hash value, a smart contract may implement the same process. A smart contract typically cannot generate random numbers; however, there is a mechanism called an oracle that provides reliable information from the outside. A smart contract can utilize the oracle to obtain a random number for use. Since the token control processing reception unit 300 is often under the control of the token provider, it is possible that the process may be implemented with a smart contract to disclose information on the blockchain network 100, where it is visible to users, to demonstrate fairness.

The latter, i.e., users can acquire as many tokens as they like, is a bigger problem. When a single user is allowed to issue or set a plurality of tokens, if the only information available as sender information is an address on the blockchain network 100, the number limit may not serve as a constraint because the user is free to create multiple addresses. One approach to address this problem is to collect user information such as name, address, and email address when a user receives token control information from a distribution means, and have the user enter the user information when they use the token control information. However, it is not feasible to obtain detailed information about a user solely through a distribution means such as a QR code or NFC, and it requires a separate system that takes time and effort to operate. It also forces users to go through the hassle, and some may feel that they are unnecessarily providing personal information, which may lead to a problem where they are reluctant to receive tokens.

To address this problem, in this embodiment, the token control information conveyed by the distribution means is encrypted to be provided. The procedures are basically the same as those illustrated in the flowchart of FIG. 3, except for some additional steps, the contents of which will be described below.

First, a cryptographic key is prepared to encrypt the control information to be stored in the token control information 600. Although the case of using public key cryptography is described in this embodiment, the same applies to the case of using common key cryptography such as advanced encryption standard (AES). Specifically, the token provider generates a private/public key pair prior to creating a token. The private key is managed by the token provider and set in the token control processing reception unit 300 in a form that can be used securely, while the public key is provided to a person who sets information for a distribution means. On the distribution means side, the control information is encrypted using the public key received for generating a random number or a serial number (step S1100). Incidentally, information such as the URL of an access destination is stored as the additional information of the token control information 600. If there is other information that needs to be kept secret procedurally, that part may also be stored encrypted. In addition, the public key used to generate information should be used only by the person who sets the token control information 600 in a distribution means and should not be made public to other workers or the outside. The subsequent process is performed as illustrated in FIG. 3, except that the token control processing reception unit 300, which has received the token control information 600 from the user in step S1300, additionally performs a process of decrypting the received information using the set private key to obtain a set random number or the like before performing the subsequent process.

In this manner, a mechanism is established in which the control information in the token control information 600 is encrypted and the key information required for the encryption is not disclosed to the user.

The method in which a private key is managed in the token control processing reception unit 300 has been described above. However, considering the possibility of internal fraud, it may also be risky to continue to keep the private key. Therefore, a description will be given of how to simplify the management by using a smart contract to hold the key.

Since the key is also data, it is not difficult to have a smart contract hold the key. However, a smart contract is information that is publicly available to anyone who has access to the blockchain network 100, and therefore it is not a good idea to let it hold the key as it is. For this reason, public key cryptography is used. Due to the technical features of public key cryptography, a public key can be easily derived from a private key. On the other hand, it is practically impossible to derive a private key from a public key because of the enormous computational time required. Taking advantage of the features, a “public key” is registered in a smart contract. The token control information 600 may be encrypted in the manner described above. The token provider generates a private/public key pair and provides the “private key” to a person who sets information for a distribution means so that the generated token control information 600 is encrypted with the key. As described above, care needs to be taken to ensure that the private key is not compromised. Once all of the token control information 600 has been created, the private key is no longer needed and may be discarded. If there is a possibility that the same private key may be used in the future for additional content or the like, the token provider strictly maintains the private key. In this case, the encrypted data is stored and managed with the sender information in the received data storage unit 700 as it cannot be decrypted in the token control processing reception unit 300. After the token control processing reception unit 300 requests the smart contract to issue or set an NFT (step S1310), the smart contract that has received the request decrypts the notified information with the public key it holds to use the information. In this manner, by holding the private/public key pair in the opposite way to how it is normally held, it is guaranteed that key information registered in the smart contract cannot be used for encryption, even if it can be used for decryption. Thus, the token control: information 600 can be used securely even when key information is registered in a smart contract.

### Third Embodiment

Allowing a user to receive a token, such as an NFT, requires information that uniquely identifies the user on the blockchain network 100. In a public blockchain such as Ethereum, an address generated from the public key of a private/public key pair managed by the user corresponds to this information. However, in order to have an address, an application or hardware such as a wallet is required to manage the private/public key pair that is the source of the address, making it difficult for general users to use tokens. Therefore, in this embodiment, how to address the problem will be described.

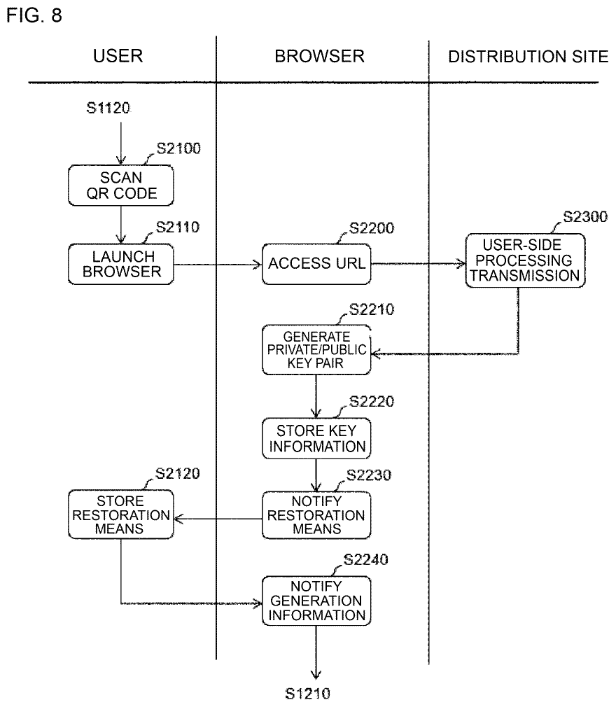

FIG. 8 is a diagram illustrating a token receiving process according to the third embodiment. The token receiving process illustrated in FIG. 8 may be performed as the process of step S1200 in FIG. 3 prior to step S1210.

In step S1200 of FIG. 3, the user obtains information from the distribution means as described above. More specifically, using a QR code as an example, the distribution means provides the user with a QR code. The QR code may be provided in any form, such as by handing out paper with the QR code printed on it, posting the QR code at the entrance of a business or the like, or distributing the QR code via the Internet. The user scans the QR code using a camera or scanner application on their smartphone (step S2100). The application to be launched may vary depending on the method provided by the distribution means. When the application scans the QR code, a URL is presented to confirm whether or not to access the URL. Having received an instruction to access the URL, the smartphone launches a browser (step S2110) and accesses the URL specified in the token control information 600 (step S2200). The instruction to access the URL may be issued automatically. In other words, when the application scans the QR code, the smartphone may automatically access the URL specified in the token control information 600.

At this time, the token control processing reception unit 300 related to the distribution site to be accessed performs user-side processing transmission (step S2300). A program such as JavaScript (registered trademark) in a page prepared by the token control processing reception unit 300 then generates a private/public key pair that is used to create an address for the user (step S2210). The private/public key pair and/or address information are stored in the local storage of the browser (step S2220). In this manner, the user can obtain the address information that is unique in the blockchain network 100 without even being aware of it. In addition, the local storage is relatively secure since it is only available to the user of the smartphone. As a modification, instead of being stored in the local storage of the browser, the private/public key pair may be stored in other browser storage such as a browser's session storage or a browser cookie, or it may also be stored in a storage or memory area other than the browser storage (e.g., a storage area in the user terminal 400, a storage area in a server accessible from the token control processing reception unit 300, etc.).

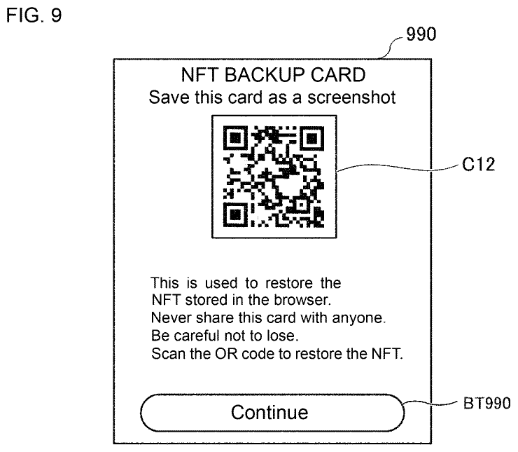

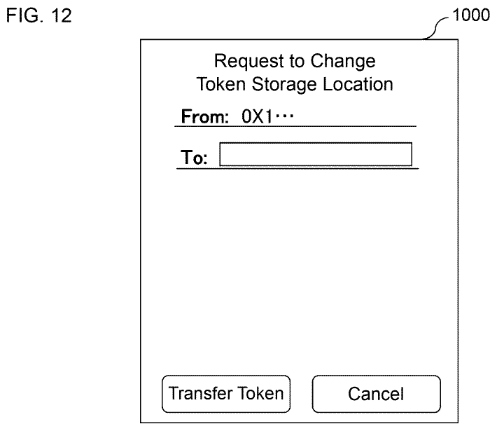

However, the local storage can be deleted by user operation. If the private/public key pair (especially the private key) is deleted, the transfer of a token issued to the user becomes permanently unavailable. To avoid this, after the private/public key pair is generated, the keys or information used to generate them are converted to a QR code and displayed to the user (step S2230). In other words, the user is notified of restoration means (restoration information) that allows the user to restore the private/public key pair (especially the private key) even if the keys have been deleted from the local storage of the browser. Thus, the user can capture the displayed screen and save it to a location other than the local storage of the browser, such as the internal memory of the smartphone or other cloud storage (step S2120). With this information, the user can regenerate the private/public key pair generated at the time of access at any time and avoid wasting a provided token. FIG. 9 illustrates an example of a user interface (UI) 990 that prompts the user to save the restoration means. In the example of FIG. 9, the UI 990 includes a QR code C12 and a message prompting the user to save the restoration means. Instead of a QR code, anything that can restore the generated private/public key pair, such as a set of words, may be used. The private/public key pair stored in the local storage of the browser can be considered as temporary information for receiving a token. Therefore, after an address in constant use by the user has been obtained, when the token control processing reception unit 300 is provided with the token to be granted, the address in constant use, and the restoration information, or the token to be granted, the address in constant use, and information on the private key stored in the local storage, it provides a function of sending the token from the address stored in the user's local storage to the address in constant use. FIG. 12 illustrates a UI image of this function. While the text displayed after “From” is the address stored in the local storage and is therefore set automatically, it may also be set (entered) manually. The box after “To” is a field for entering wallet information that can identify a corresponding wallet, such as the address in constant use or the like (e.g., an address for proxy processing when going through proxy processing, etc.), which is entered by the user. The information for “To” may be set by reading it from a QR code or the like. It is assumed here that the restoration information is stored as a separate file.

Thereafter, in response to an instruction from the user, the process of requesting the acquisition of the NFT (step S1210 in FIG. 3) is performed after the process of notifying generation information in the browser (step S2240). The distribution means provides the token control information 600, and processes such as obtaining necessary information from the token control information 600 and encrypting it may be performed in the process of notifying generation information (S2240). Part or all of the token control information 600 may be incorporated in the corresponding URL or included in a web page that is opened based on the corresponding URL.

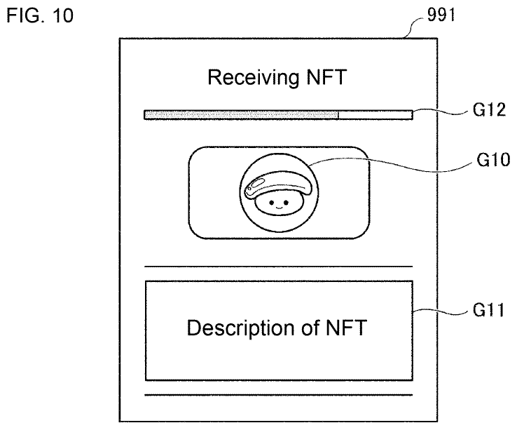

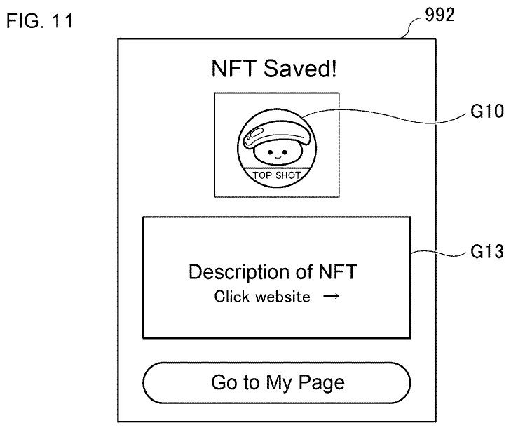

For example, in the case of FIG. 9, when the user presses a button BT990 labeled “Continue” on the smartphone, the process from step S1210 in FIG. 3 is performed after step S2240. In this case, a UI 991 as illustrated in FIG. 10 may be output on the user's smartphone via the UI 990 of FIG. 9. In the example of FIG. 10, the UI 991 displays a screen which includes an image G10 representing the token (NFT) to be acquired, its description G11, and a processing indicator G12 visually indicating that the acquisition is in progress. The user can obtain information about the NFT being acquired by viewing the screen of the UI 991. The description G11 may contain advertising or promotional information related to the distributor. FIG. 11 illustrates a UI 992 displayed when the acquisition is complete, which includes the message “NFT Saved!”. As mentioned above, the “save” here refers to the saving to or storing in the local storage of the browser. The UI 992 illustrated in FIG. 11 displays a screen including the image G10 representing the saved token (NFT) and its description G13. The description G13 may contain a link to a more detailed description screen, a link to a site related to advertising information, or the like.

In the example of FIG. 8, a process is performed to prompt the user to save the restoration means (step S2230); however, this process may be skipped, or it may be performed after the transaction with a later notification. In addition, although FIG. 8 does not explicitly indicate the process of creating an address for the public blockchain, since the address is generated from a public key, it may be created in the process of generating a private/public key pair (S2210).

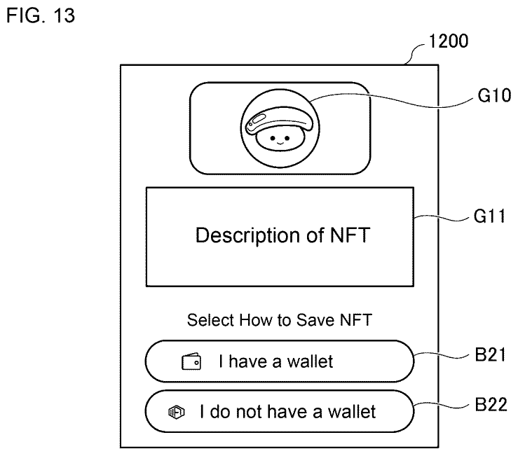

Additionally, in this embodiment, information (in this example, a web page) displayed based on the URL destination specified in the token control information 600 may include a UI that allows the user to select where to store the token (NFT) to be acquired. FIG. 13 illustrates an example of such a UI 1200 including a button B21 that may be selected by a user who has a wallet and a button B22 that may be suitable for selection by a user who does not have a wallet. When the user presses the button B21, the token to be acquired is associated with the address in constant use, which eliminates the need for the process described above with reference to FIG. 12. On the other hand, if the user presses the button B22, various processes are performed as described above with reference to FIG. 8, and the token can be granted to the user who does not have a wallet. In this manner, by providing a UI that allows users to select where to store a token (NFT) to be acquired, it is possible to provide a highly convenient service to a wide range of users.

Incidentally, a processing request to the blockchain network 100 may incur a fee, referred to as a gas fee, in many blockchains. The gas fee is required to be paid using basic tokens in each blockchain; however, it is difficult for ordinary users to secure such tokens for the gas fee. To address this, a method is provided in which processing for the blockchain network 100 is created using the user's private/public key pair, and the gas fee required for a request for the processing is borne by the token control processing reception unit 300. Using the private key of the private/public key pair stored in the local storage, the user terminal 400 signs the token control information 600 received from the distribution means and notifies the token control processing reception unit 300 that it will use the information for certain, thereby requesting to cover the gas fee. The token control processing reception unit 300 can reliably verify the sender from the sender information and the signature, and accepts the payment of the gas fee based on the verification. In addition, a smart contract that can handle a proxy request for the processing is prepared in the blockchain network 100, and the token control processing reception unit 300 achieves the proxy processing by requesting the smart contract to perform the processing. In this manner, by having the token control processing reception unit 300 perform processing for the blockchain network 100 on its behalf, the user can send a processing request to the blockchain network 100 without being concerned about gas fees. While there has been a description of how to send a held token to an address in constant use, this can also be achieved by proxy without providing private key information or the like. There are roughly two methods. In one method, the user creates a processing request to send the target token from the address of the private/public key pair stored in the local storage to an address in constant use prepared by the user, signs it with the private key in the local storage, and sends the processing request to the token control processing reception unit 300. In the other method, the user creates a processing request to authorize the token control processing reception unit 300 to operate the target token, signs it with the private key stored in the local storage or the like, and sends the processing request to the token control processing reception unit 300. In either case, upon receipt of the request, the token control processing reception unit 300 sets a gas fee and then requests a smart contract that implements proxy processing to perform the processing, thereby completing the processing. If the storage location of a token is to be changed by these methods, there is no need for the item of restoration information in the UI 1000 of FIG. 12. Therefore, in this case, the two methods may be presented so that the user can select one, or the system may be implemented to use one of the two methods so that there is no option on the UI. When proxy processing is actually performed, the received data storage unit 700 of FIG. 5 is referenced to confirm whether the requester is valid, and then a proxy processing request is made to the blockchain network 100. It may also be determined whether or not to perform proxy processing with reference to information in the received data storage unit 700. In addition, it may be possible to provide rules that, for example, since QR codes are distributed in large numbers, the gas fee is subsidized for those who have acquired an NFT through audio but not for those who have acquired an NFT through a QR code, or that the gas fee is covered and a small amount that can be used for future gas fees is given as a gift for those who have acquired an NFC within three days, only the gas fee is covered for those who have acquired an NFC within one month, and requests for subsidies are not accepted after that. Such a rule allows for the weighting of a particular distribution means, increasing the variation in the way NFTs can be distributed.

### Other Embodiments

While preferred embodiments of the invention have been described and illustrated, the invention is not limited to the embodiments disclosed herein. Various changes, modifications, and alterations may be made within the scope of the invention as defined in the appended claims. Furthermore, all or some of the constituent elements described in the above embodiments may be variously combined.

In the following, additional notes will be provided with respect to the above embodiments.

### Additional Note 1

A token control system that controls tokens in circulation on a blockchain network made up of a plurality of computers, the system comprising: a token processing unit that manages and processes a token; a token control processing reception unit that notifies the token processing unit of token control information in response to an instruction from a user terminal and sends a result from the token processing unit to the user terminal; and a distribution means for distributing information to the user terminal, wherein the distribution means sets a random number or information set by a predetermined rule as part of the token control information to be distributed to the user terminal, the user terminal notifies the token processing unit of the token control information through or not through the token control processing reception unit, the token control processing reception unit or the token processing unit stores the token control information received from the user terminal together with user information about the user terminal that has sent the token control information, and the token processing unit refers to the random number or the information set by the rule that the distribution means has set in the token control information to use the random number or the information set by the rule as specific or identifying information about the token managed by the token processing unit.

### Additional Note 2

In the token control system as set forth in additional note 1, the token processing unit includes an information modification processing unit that modifies the random number or the information set by the rule stored in the token control information such that the information falls within a certain range. When first modified information obtained by modifying the random number or the information set by the predetermined rule is the same as existing information stored in the token control information, the modification processing unit further modifies the first modified information into second modified information such that the token control information falls within a certain range. The token processing unit uses the first modified information or the second modified information as information for identifying the token that it manages to perform control on the identified token.

### Additional Note 3

In the token control system as set forth in additional note 2, as well as modifying the information to fall within a certain range in the modification processing unit, the token processing unit divides the range into divisional ranges and weights them. When the information has been modified to be the same as existing information in the modification processing unit, the token processing unit modifies the information again in the modification processing unit such that the information falls within a divisional range. The token processing unit uses the information that falls within the divisional range as information for identifying the token to perform control on the identified token.

### Additional Note 4

In the token control system as set forth in additional note 2 or 3, the token processing unit refers to additional information stored in the token control information when modifying the information to fall within a certain range in the modification processing unit.

### Additional Note 5

In the token control system as set forth in additional notes 2 to 4, the token processing unit controls the assignment range and the assignment number according to the distribution means in the modification processing unit.

### Additional Note 6

In the token control system as set forth in additional notes 3 to 5, depending on the transmission date and time when the user terminal has sent the token control information and/or a combination of distribution means, the token control processing reception unit or the token processing unit determines whether or not to accept a processing request and how to modify the information in the modification processing unit, and changes the weighting of the divisional ranges of the range, before performing control on the identified token.

### Additional Note 7

In the token control system as set forth in additional notes 2 to 6, when the information modification processing unit modifies information to fall within a certain range, the token control processing reception unit or the token processing unit calls a random number generator function operated on the blockchain network to generate a random number. The information modification processing unit combines the random number or the information set by the predetermined rule with the generated random number to generate third modified information. The third modified information is used as an input to the information modification processing unit.

### Additional Note 8

In the token control system as set forth in additional notes 1 to 7, the distribution means encrypts information used by the token processing unit out of the token control information to generate encrypted information. The token control processing reception unit or the token processing unit has a decryption cipher key and uses the decryption cipher key to decrypt the encrypted information to use it. In the case where the token processing unit decrypts the encrypted information, the public key of a private/public key pair is registered in the token processing unit.

### Additional Note 9

In the token control system as set forth in additional notes 1 to 8, when sending the token control information to the token control processing reception unit or the token processing unit, the user terminal automatically generates information necessary to uniquely identify the user in the blockchain network in a memory or storage that can be used only by the user terminal, or retrieves the uniquely identifying information if it is stored in the memory, and sets the generated uniquely identifying information in the token control information to be sent.

### Additional Note 10

In the token control system as set forth in additional note 9, when generating the uniquely identifying information, the user terminal generates information for restoring the generated uniquely identifying information. The user terminal presents the information to the user and provides a notification that instructs the user to save it.

### Additional Note 11

In the token control system as set forth in additional note 9 or 10, when obtaining information that uniquely identifies the user in the blockchain network and that the user constantly uses, the user terminal retrieves the generated uniquely identifying information managed in the memory that can be used only by the user terminal. A UI is provided for instructing updating of user information to send the token that the user is authorized to use and that is managed by the token processing unit from the generated uniquely identifying information to the uniquely identifying information in constant use, and the user information is updated in response to an instruction from the UI.

### Additional Note 12

In the token control system as set forth in additional notes 9 to 11, the user terminal signs a processing request to the blockchain network with a private key stored in the user terminal, and requests the token control processing reception unit to perform proxy processing. The token control processing reception unit covers the fee required for the processing request to the blockchain network on behalf of the user and sends the processing request to the blockchain network.

### Additional Note 13

In the token control system as set forth in additional note 12, when the token control processing reception unit performs the proxy processing, the user terminal refers to the token control information stored in the token control processing reception unit. Before requesting processing from the blockchain network, the user terminal determines whether or not to perform the proxy processing according to the content of the token control information, or determines additional processing to be performed during the proxy processing, and accordingly, the proxy processing, including the additional processing, is performed or not performed.

### LIST OF REFERENCE SIGNS

100 Blockchain network
600 Token control information
700 Received data storage unit
800 Token management information
900 Token distribution number management
1000 Token storage location change UI

1. An information processing device, configured to perform a first process based on an acquisition request generated by a user terminal to acquire a token that can be circulated on a blockchain network, wherein
the first process generates predetermined information that enables acquisition or management of the token and stores the predetermined information in a predetermined storage area pertaining to the user terminal or a server.

2. The information processing device according to claim 1, wherein the predetermined storage area includes a browser storage.

3. The information processing device according to claim 1, wherein the predetermined information includes information related to a private key.

4. The information processing device according to claim 1, further configured to perform a second process that changes a state of the token from a first state of being managed on the blockchain network through the predetermined information to a second state of being managed through a wallet accessible by a user.

5. The information processing device according to claim 4, wherein the second process is performed based on the predetermined information and wallet information that can identify the wallet.

6. The information processing device according to claim 1, further configured to perform a third process that issues a notification notifying the user terminal of restoration information that enables the predetermined information to be restored.

7. The information processing device according to claim 1, wherein
the acquisition request is generated based on token control information related to the token, and
the token control information includes identifying information about the token, which is set based on a random number or a predetermined rule.

8. The information processing device according to claim 7, wherein
the token control information includes information for accessing a predetermined URL, and
the acquisition request is generated based on access to the predetermined URL.

9. The information processing device according to claim 8, wherein the acquisition request is generated based further on a first predetermined input at the predetermined URL.

10. The information processing device according to claim 9, wherein
information displayed based on the predetermined URL includes a user interface that allows a user to selectively enter the first predetermined input or a second predetermined input that is different from the first predetermined input, and
the token enters into a state of being managed through a wallet accessible by a user based on the second predetermined input.

11. The information processing device according to claim 8, wherein the first process is performed on a browser by a program prepared in association with the predetermined URL.

12. The information processing device according to claim 5, wherein
the user terminal signs a processing request to the blockchain network with a private key stored in a storage of the user terminal or a browser,
the second process is performed based further on address information related to the predetermined information and the signed processing request, and
the address information is entered on a user interface in the browser.

13. The information processing device according to claim 6, wherein the third process includes outputting information that prompts a user to save the restoration information together with the notification.

14. A computer program product comprising a non-transitory computer-readable medium having a computer-readable program code embodied therein, wherein the computer-readable program code, when executed on a computer, causes a computer to perform a first process based on an acquisition request generated by a user terminal to acquire a token that can be circulated on a blockchain network, wherein
the first process generates predetermined information that enables acquisition or management of the token and stores the predetermined information in a predetermined storage area pertaining to the user terminal.

15. An information processing method, comprising:
causing a computer to perform a first process based on an acquisition request generated by a user terminal to acquire a token that can be circulated on a blockchain network, wherein
the first process generates predetermined information that enables acquisition or management of the token and stores the predetermined information in a predetermined storage area pertaining to the user terminal.
